(19) United States
(12) Patent Application Publication
(10) Pub. No.: US 2025/0035740 A1
(43) Pub. Date: Jan. 30, 2025

(54) RADAR RANGE RATE DISAMBIGUATION BY COHERENT RANGE TRACKING

(71) Applicant: GM Cruise Holdings LLC, San Francisco, CA (US)

(72) Inventor: Aravind Ramachandran, Cupertino, CA (US)

(21) Appl. No.: 18/361,583

(22) Filed: Jul. 28, 2023

(51) Int. Cl. G01S 7/288; G01S 13/58

(52) U.S. Cl. CPC G01S 7/2883; G01S 13/581

(57) ABSTRACT

The present disclosure generally relates to identifying an actual velocity of an object and in particular, for identifying an actual velocity of an object by taking into consideration alias velocities computed using a radar device. A process of the disclosed technology can include steps for transmitting a set of radar pulses to determine an initial velocity estimate associated with an object, calculating a first peak energy return value corresponding with the initial velocity estimate, and selecting an alias velocity based on the first velocity estimate. In some aspects, the process can further include steps for calculating a second peak energy return value corresponding with the alias velocity, and comparing the first peak energy return value with the second peak energy return value to determine an actual velocity of the object. Systems and machine-readable media are also provided.

### BACKGROUND

### 1. Technical Field

The present disclosure generally relates to identifying an actual velocity of an object and in particular, for identifying an actual velocity of the object by taking into consideration alias velocities computed using a radar device.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst other sensors. The sensors collect data and measurements that the autonomous vehicle can use for operations such as navigation. Since modern radar devices analyze acquired radar data in a manner that may include ambiguities, these radar devices must be engineered to eliminate ambiguous data such that unambiguous data may be used by one or more processors when a controller of an autonomous vehicle (AV) drives the AV along a roadway.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a radar device that transmits radar pulses, according to some examples of the present disclosure;

FIG. 2 illustrates a graph that cross-references range information and timing information associated with samples collected by a radar device, according to some examples of the present disclosure;

FIG. 3 illustrates representations of different sets of mathematical operations that may be performed on sets of sampled data, according to some aspects of the present disclosure.

FIG. 4 illustrates an example of data that has been placed into range bins such that evaluations consistent with the present disclosure may be performed, according to some examples of the present disclosure;

FIG. 5 illustrates another example of data that may have been placed in or associated with a range bin that stores data associated with a detection signal or energy pulse, according to some examples of the present disclosure.

FIG. 6 illustrates actions that may be performed when a range to an object and a velocity of the object are identified during a single coherent processing interval of a radar device, according to some examples of the present disclosure.

FIG. 7 illustrates an example system environment that can be used to facilitate autonomous vehicle (AV) dispatch and operations, according to some aspects of the disclosed technology;

FIG. 8 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Described herein are systems, apparatuses, processes (also referred to as methods), and computer-readable media (collectively referred to as “systems and techniques”) for deriving measurements from data received by one or more autonomous vehicle (AV) sensors, such as one or more radio detection and ranging (RADAR) devices. In AV applications, radar sensors are commonly used to provide range (distance that separates an object and a radar device) and velocity information for objects in a surrounding environment. However, velocity (or range rate) estimates are ambiguous due to finite sampling of the radio frequency (RF) pulses transmitted and received by the radar. Such ambiguities can cause moving targets to alias as slower or faster moving velocities. To determine actual object velocities, ambiguities are sometimes resolved by collecting multiple frames of radar measurement data, and hypothesizing different parameter values to determine what values most consistently match acquired data. Because of the need for collecting and processing multiple radar frames, such approaches to resolving velocity ambiguities can introduce unacceptable delays for AV deployment contexts.

Aspects of the disclosed technology provide solutions for disambiguating velocity estimates using ambiguous measurement data, such as by utilizing a novel process for identifying actual object velocities from a single radar frame. Such processes leverage the observation that rapidly moving objects migrate in range during the radar's coherent processing interval (CPI). A CPI may correspond to a single radar processing frame. As such, range migration can be tracked (e.g., across a single radar frame) to determine actual object velocities, e.g., by eliminating velocity aliases. As discussed in further detail below, the proposed Doppler processing approach can be performed by computing velocity estimates using a first set of range assumptions, and then recomputing the velocity estimates using a second set of range assumptions which account for range migration. The more accurate velocity estimate (e.g., the actual object velocity) can correspond to that which returns the greatest peak energy.

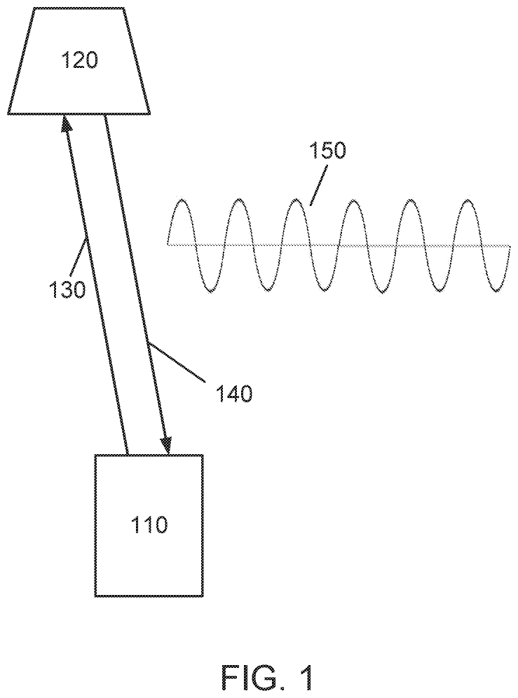

FIG. 1 illustrates a radar device that transmits a pulse of radar signal that is reflected off an object and back toward the radar device. Radar device 110 transmits radar pulse 130 toward object 120 where at least some energy of radar pulse 130 is reflected back toward radar device 110 as radar pulse 140. Radar pulses 130 and 140 may include multiple periods of a 77 gigahertz swept frequency signal. This means that there is a small timing delay between when radar pulse 130 is transmitted and when radar pulse 140 is received. Because of this, once reflected radar pulse 140 is received, it may be mixed with radar pulse 130 to generate baseband signal 150. The period of baseband signal 150 may vary depending on the timing delay between when radar pulse 130 was transmitted and when reflected radar pulse 140 was received. Since the timing delay varies with the distance that separates the radar and the object, the period and frequency of baseband signal 150 also varies with separation distance. Once baseband signal 150 is generated, it may be sampled by an analog to digital converter (ADC) using a sampling frequency of 50 megahertz, for example. When the sampling frequency of 50 megahertz is used, the radar apparatus may identify baseband signals that have frequencies up to 25 megahertz. Radar devices may generate a baseband signal for each radar pulse transmitted by the radar device. The terms separation distance and range may be used interchangeably.

A radar signal transmitted toward object 120 must travel twice the distance that separates radar device 110 from object 120. Since radar pulses 130 and 140 travel at the speed of light, the amount of time it takes for a first cycle of radar signal to travel to object 120 and back to radar device 110 corresponds to the distance separating object 120 from radar device 110. In instances when there is relative movement between radar device 110 and object 120, pulses of radar pulse 140 and generated baseband signal 150 may be shifted in phase based on an effect known as the Doppler effect. This means that pulses of radar pulse 140 may appear to be squeezed or stretched relative to timing of radar pulse 130. In such an instance, the amount of phase shift of pulses of radar pulse 140 and baseband signal 150 corresponds to a relative velocity between radar device 110 and object 120. Because of this phase shift effect, the velocity of the object may be estimated.

When radar device 110 samples radar pulse 140, aliasing effects associated with a digitally sampled radar system discussed above may result in the radar device not being able to discriminate between an actual velocity of the object and other possible velocities by comparing phase shifts alone. Because of this, other methods may be used to identify which velocity amongst a set of aliased velocities is the actual velocity. This set of aliased velocities may include the actual velocity and other velocities that would cause a similar amount of phase shift detected by radar device 110.

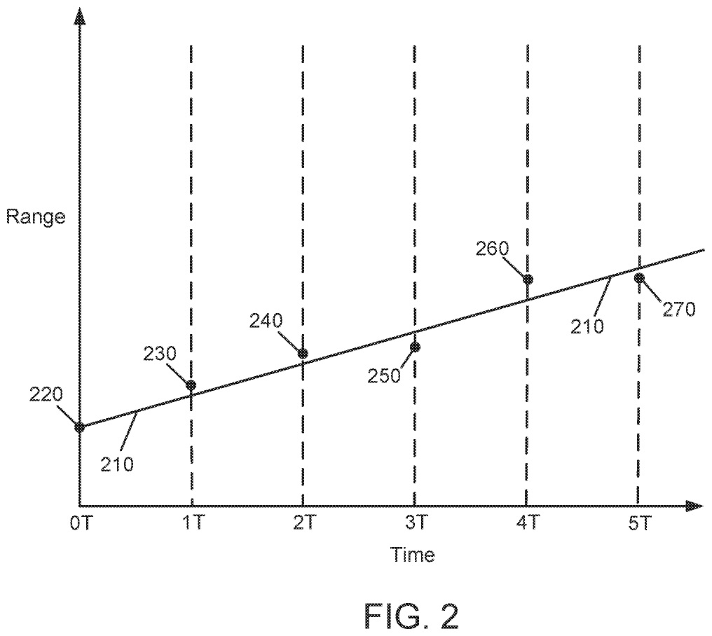

FIG. 2 illustrates a graph that cross-references range information and timing information associated with samples collected by a radar device. The graph of FIG. 2 includes a vertical axis of range and a horizontal axis of time. This graph also includes sample data (220, 230, 240, 250, 260, and 270) of different baseband signals collected by the radar device. Line 210 represents an average change in range (distance between the radar device and the object) over time. Line 210 increases in value with time, indicating that the distance between the object and the radar device is increasing over time. This means that the object and the radar device are moving away from each other at a velocity that corresponds to the slope of line 210.

Note that some of the data samples in FIG. 2 are below line 210 (e.g., 250, 270) and some of these dots are above line 210 (e.g., 230, 240). This may be caused by the presence of electromagnetic noise and/or other factors. These dots or sets of sampled data 220, 230, 240, 250, 260, and 270 are associated respectively with times of 0T, 1T, 2T, 3T, 4T, and 5T and with a different respective radar pulse. Each of the sampled datasets 220, 230, 240, 250, 260, and 270 of FIG. 2 may include data representative of a particular frequency that corresponds to the range to the object at a particular time.

Operation of the radar device may include transmitting a first radar pulse, receiving a reflection of that first radar pulse, generating a first baseband signal, sampling the first baseband signal, and placing information representative of that first baseband signal into a column of data. The radar device may repeat this same sequence many times (e.g., 64, 128, or 256 times) over a CPI of the radar device. A set of fast Fourier transforms (FFT) may be performed on respective sets of sampled data. An FFT may be performed on each column of the sampled data. This means that an FFT may performed on sampled data of each baseband signal. As mentioned above, the frequency of the baseband signal varies with separation distance (i.e., range). Since these FFTs are associated with range, they may be referred to as range FFTs. A range FFT may be performed for each pulse transmitted by the radar apparatus. As such the first mathematical operations (e.g., the range FFTs) may transform sensed data from the time domain to the frequency domain.

The range FFTs allow the processor to identify frequencies of each of the baseband signals sampled by an ADC. Since the frequency of the baseband signal corresponds to the range to the object at a particular time, the processor may identify the range to the object at each of times 0T, 1T, 2T, 3T, 4T, and 5T from data generated by the range FFTs. After performing these range FFTs, a second set of mathematical operations may be performed such that an actual velocity of the object can be determined. This may include a technique referred to herein as range migration.

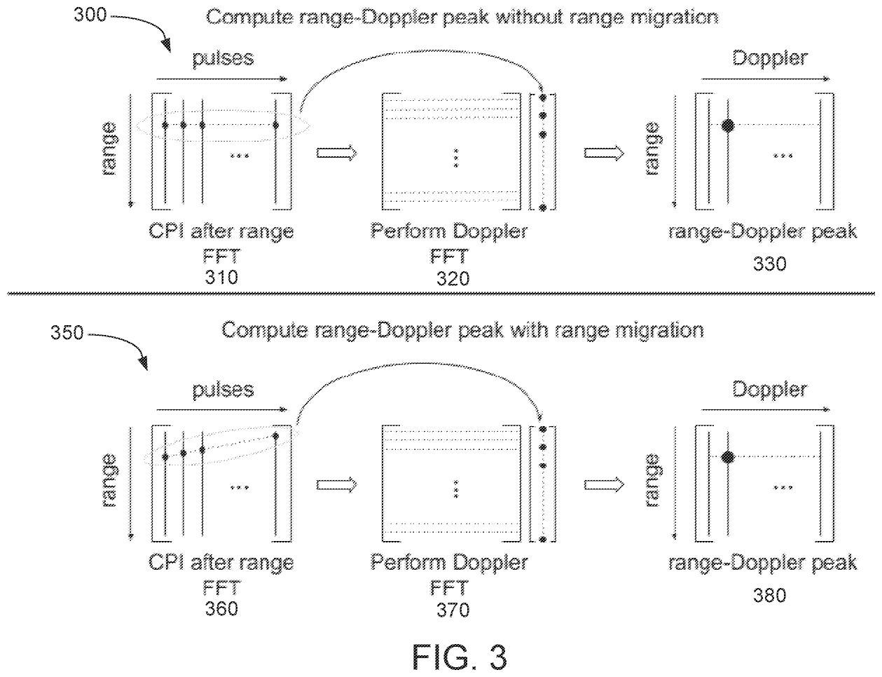

FIG. 3 illustrates representations of different sets of mathematical operations that may be performed on sets of sampled data. These different sets of mathematical operations may include a first mathematical operation (e.g., a range FFT) performed on sampled data followed by a second mathematical operation (e.g., a Doppler FFT) performed on results of the first mathematical operation. The first set of mathematical operations may transform time-domain data (samples of a baseband signal) to frequency data that correspond to range. The second set of transformations may convert the frequency data to phase information. This is illustrated by images 310, 320, and 330 of representation 300 and by images 360, 370, and 380 of representation 350.

Image 310 is a matrix (matrix 310) that shows sampled data associated with respective radar pulses that that has been converted into range data and placed in matrix 310. As mentioned above, a baseband signal may be generated by mixing a first signal pulse and a reflection of that first signal pulse, the baseband signal may be sampled to generate a first set of sampled data, and range FFTs may be performed on the first set of sampled data. The results of these range FFTs on the first set of sampled data may be placed into the left column of matrix 310. The location of the black dot located in the upper left portion (along a first columnated line) of matrix 310 corresponds to the range to the object when the first signal pulse was transmitted. This process may be repeated for each pulse of a set of transmitted pulses, and matrix 310 may be populated with the results of range FFTs for every pulse transmitted during a CPI.

Each respective dot of matrix 310 corresponds to a respective radar pulse and a range to the object at a specific time. Since the radar apparatus is a digitally sampled system, data included in matrix 310 may be associated with both a span of range (range span) and a span of time (time span). As such, the dots included in matrix 310 may identify range spans where the object was located during time spans when each respective radar pulse was transmitted. In other words, matrix 310 includes data representative of range to an object at discrete times that were identified using range FFTs on sampled baseband signals generated from numerous (e.g., 64, 128, or 256) mixed radar pulses. The range FFTs transform the time-based baseband signals into frequency data that corresponds to range to the object for each radar pulse of a plurality of radar pulses. Data of matrix 310 may be organized as a set of bins where each column of data is associated with a plurality of range spans and a single time span and where each row of data is associated with a plurality of time spans and a single range span. In instances when multiple objects are in the field of view of the radar device, sensed data of matrix 310 may include information associated with different objects located at different ranges from the radar device.

An example of a set of range spans used by a radar device may include a first range span that spans distances of 1000 cm to 1024 cm, a second range span that spans distances of 1025 cm to 1049 cm, a third range span that range span that spans distances of 1050 cm to 1074 cm, and other range spans that span distances of 25 cm. While the horizontal dashed line connecting the dots of matrix 310 appears to be horizontal, the object may still be moving relative to the radar device. This could mean that range to the object has not changed by more than 25 cm over the time it took for the radar device to transmit the set of (e.g., 64, 128, or 256) radar pulses during a single CPI.

After the first set of mathematical operations (e.g., range FFTs) has been performed, a second set of mathematical operations may be performed over the rows of matrix 310 as indicated by image 320 of FIG. 3. This second set of mathematical operations may be a second set of FFTs or sums that transform data from the frequency information to phase information (phase shift). Since this second set of mathematical operations generate phase information, they may be referred to as Doppler FFTs that are performed using data from a set of rows of matrix 310. The horizontal dashed line in image 320 indicates that data from the same range span and different time spans may be transformed into a set of phase information using the Doppler FFTs. This means that data from matrix 310 may be transformed into data placed in matrix 330 using the Doppler FFTs of image 320. Since representation 300 uses data from the same range span and different time spans, evaluations using data from matrix 330 could only accurately map instances when the object stays with a specific range during a CPI.

In contrast, representation 350 illustrates similar evaluations being performed using a technique of range migration that performs Doppler FFTs using different range spans and different time spans. This range migration technique may more rapidly identify the actual velocity of an object as compared to conventional methods. Representation 350 includes matrix 360 that includes results of the first set of mathematical operations (e.g., the range FFTs) on data of an object that moves between range bins during a CPI. Image 370 shows that the second set of mathematical operations (e.g., Doppler FFTs) may be performed on the data of matrix 360 to generate the data of matrix 380. Here, however, the second set of mathematical operations are performed using a range migration technique, where data from different range spans and different time spans generate the data of matrix 380.

When the second set of mathematical operations (e.g., Doppler FFTs) are performed using data from range bins (range spans and time spans) that track an objects actual velocity, a result will have a greater peak value (range-Doppler peak) as compared to similar operations performed using range bins that do not track the objects actual velocity. Changes in phase of a signal associated with a moving object correspond to the velocity of the object relative to the radar apparatus. This means that shifts in phase of baseband signals correspond to the velocity of the object. Since the radar apparatus is a digitally sample system, a particular phase shift of the baseband signals may map to more than one potential velocity because of ambiguities caused by aliasing. Because of this, techniques of the present disclosure may identify multiple potential velocities (e.g., an actual velocity and aliases of that actual velocity) of the object from phase shift (Doppler frequency) information and then calculate range-Doppler peaks for each of those multiple potential velocities. The range-Doppler peak that has the greatest value will correspond to the actual velocity because the sum generated by the Doppler FFTs uses energy data from range bins that correspond to actual motion of the object relative to the radar device. The phase shift information mentioned above may be identified by performing a range-FFT on one or more baseband signals, performing a Doppler FFT on results of the range-FFT, and then identifying the Doppler frequency information from results of the Doppler FFT.

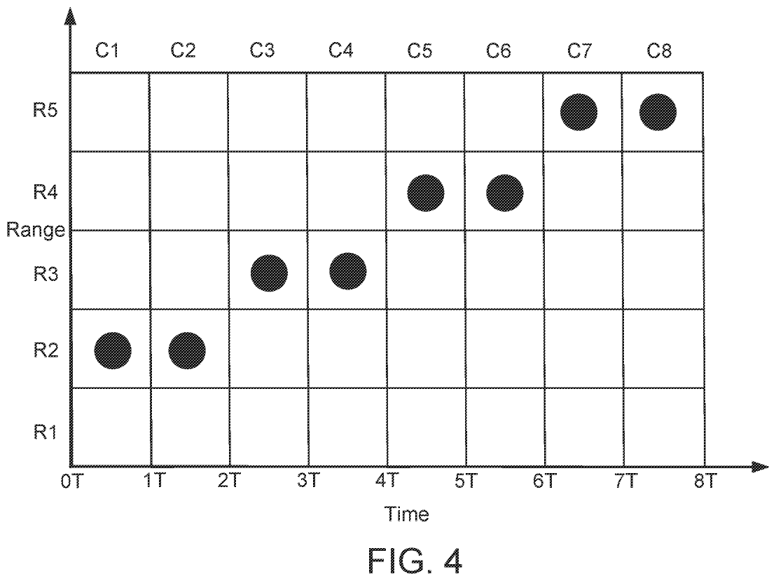

FIG. 4 illustrates an example of data that has been placed into range bins (or in memory locations that correspond to a respective range bin) such that evaluations consistent with the present disclosure may be performed. FIG. 4 includes a vertical axis of range and a horizontal axis of time where sensed data has been placed into bins that are associated with particular range spans and particular time spans. Each of the large dark circles or dots of FIG. 4 may represent one or more detections of an object over time. Each of these detections may have been made by a processor of the radar device from baseband signals and data associated with these detections may be placed into a range bin by the processor of the radar device. The horizontal axis identifies timing bouderies of 0T, 1T, 2T, 3T, 4T, 5T, 6T, 7T, and 8T.

The range bins may be organized in a column and row format, such as columns C1, C2, C3, C4, C5, C6, C7, and C8; and rows R1, R2, R3, R4, and R5. Each specific range bin may be identified using a notation that specifies a column indicator and a row indicator that are separated by a hyphen. For example, the range bin located at column C1 and row R1 may be identified by indicator C1-R1. Using this type of notation, range bins that include object detection data are identified by the large dark circles shown in range bins C1-R2, C2-R2, C3-R3, C4-R3, C5-R4, C6-R4, C7-R5, and C8-R5. Note that other range bins (e.g., C1-R1) besides range bins C1-R2, C2-R2, C3-R3, C4-R3, C5-R4, C6-R4, C7-R5, and C8-R5 do not include data that corresponds to an object.

Data sensed, stored, or used by a radar device may include a value of sensed data, a time when that sensed data was received, a magnitude of energy associated with a sensed data sample, the presence or absence of an object detection (e.g., a binary yes=>1 or no=>0 indication), a number of detections, a range bin identifier, or combination thereof. Energy sensed by a radar device may only include noise (noise energy). This noise energy and the presence of less than some measure (e.g., a threshold level) of sensed energy may indicate that this sample is not or should not be associated with an object. Because of this, a magnitude of a sensed data point that is less than a threshold amplitude may be used to eliminate noise from being included in a set of sampled data.

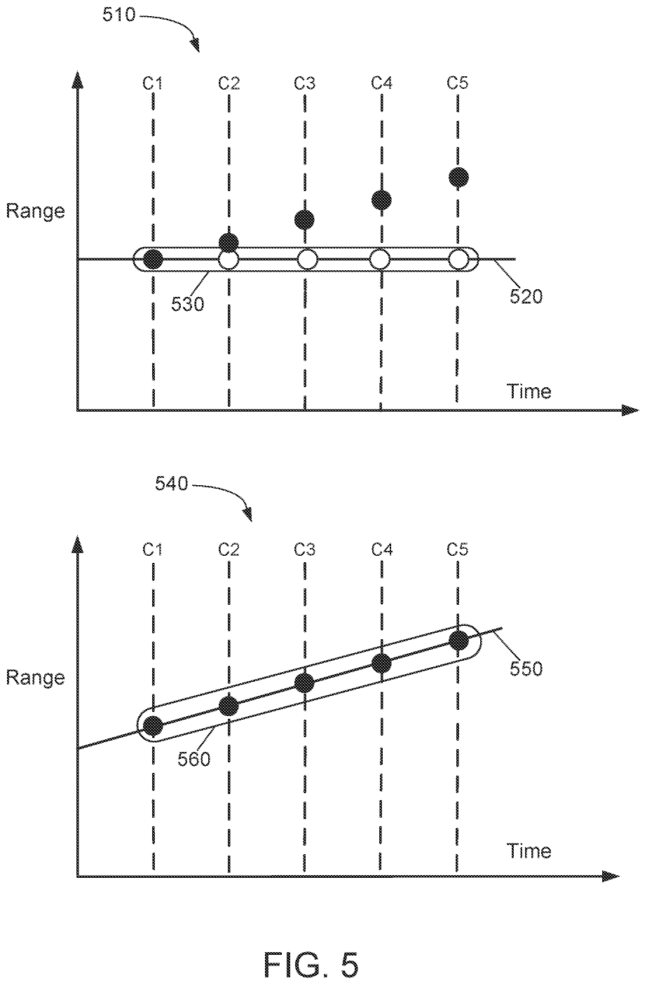

FIG. 5 illustrates another example of data that may have been placed in or associated with a range bin that stores data associated with a detection signal or energy pulse. FIG. 5 includes a first graph 510 and a second graph 540. Graphs 510 and 540 include a set of dark circles that correspond to data indicative of the presence of an object moving between specific range bins over time. Each of these dark circles are located within a column of data as indicated by the vertical dashed lines respectively labeled C1, C2, C3, C4, and C5. Methods of the present disclosure may identify an actual velocity of and range to an object from data collected during a single coherent processing interval (CPI) or time of a radar frame. This CPI or radar time frame spans the time it takes for a radar device to transmit and receive a single set of radar pulses and may include a dwell time when the radar device does not transmit radar pulses. In certain instances, CPI or radar time frame may be divided into a set of equally spaced time intervals that corresponds to a range bin time span. The dark circles of graphs 510 and 540 may correspond to peaks of data identified by summing a column of range bin data or by performing a range-FFT on sampled data.

Each of the dark circles of graphs 510 and 540 may be evaluated by a processor to identify a distance or range span and a time span where an object was located at a moment in time. The graphs 510 and 540 of FIG. 5 show that the object is moving between range bins for each column of a plurality of range bin columns. In certain instances, objects in the field of view of a radar apparatus may not really be able to move from one range bin to another in a time span associated with a single range bin. For example, in an instance when an automotive application uses range bin distance spans of 25 cm and range bin time spans of 500 microseconds (μs) an object would have to move at a velocity of 500 meters per second (1118.5 miles per hour) to move from one range bin to a next range bin over the course of two time spans as illustrated in FIG. 4. Since this is much faster than an automobile can move, the object moving between range bins in FIG. 4 is illustrative.

An operation that sums data from columns of range bins may be a range-FFT that is used to identify peaks associated with a particular time span and multiple range spans. This means that the dark circles of graphs 510 and 540 correspond to locations where a sum of range bins in a column of range bins peaks for a given column of data (C1, C2, C3, C4, and C5). Radar transforms discussed herein may convert a data matrix from different time domain samples into a different representation by performing the first set of mathematical operations (e.g., range FFT) and the second set of mathematical operations (e.g., Doppler FFT) discussed above. In an instance when 64 radar pulses are used in a CPI or radar frame, range FFTs may be performed on sampled data for each of those pulses, and Doppler FFTs may be performed on results of the range FFTs. This may include performing a range FFT of each of 64 columns of sampled data. A processor performing this range FFT may then overwrite data stored in a matrix format. Such a “range-FFT matrix,” may now include complex number entries. Such a range-FFT matrix may be matrix 360 of FIG. 3. Each row of this new range matrix may correspond to a range bin. If there was an object present at a given range, we would expect a reflection at the corresponding range bin for each of the 64 pulses that the radar device transmitted. At this time, a processor at the radar device may identify whether or not a target is present at each range bin. Instead, this processor may perform an FFT of each row of the new complex range-FFT matrix (so it may take, for example, 1024 such row FFTs, one for each range bin). This may convert the samples at that same range bin from pulse to pulse into a different complex number. In such an instance, the domain across columns is no longer pulse number, yet it is the Doppler frequency (which is proportional to the radial velocity). Next, in this matrix, the processor at the radar device may check the magnitude of each entry to see if there is sufficient energy (i.e., it may compare the magnitude in that entry with a threshold). When this magnitude meets or exceeds the threshold, the processor may declare that an object is or was located at the corresponding row (range bin) and column (radial velocity). In automotive example above, an object will tend to say within a specific range bin over several time spans. As such, a graph that depicts actual movement may appear as a series of steps as shown in FIG. 4.

Graph 510 includes line 520 that intersects a dark circle that is located along dashed line of dashed C1 and light circles along dashed lines C2, C3, C4, and C5. This dark circle and these light circles of graph 510 are located within an area of ellipse 530. In contrast, the circles located within ellipse 560 of graph 540 (along line 550) may more accurately characterize movement of the object over time. Note that the dark circles in graphs 510 and 540 both intersect dashed lines C1, C2, C3, C4, and C5 where range changes with time within a single CPI. Ellipse 560 identifies range bins that may be used in a transform when the range migration technique of the present disclosure is performed.

Systems and techniques of the present disclosure may identify an actual velocity of an object more rapidly than other methods. This is because other methods identify an object's location for each CPI and then compare those locations to identify range and velocity of the object. This means that these other methods evaluate data collected from multiple CPIs to identify object velocity, where methods of the present disclosure identify the actual velocity of the object from data collected during a single CPI.

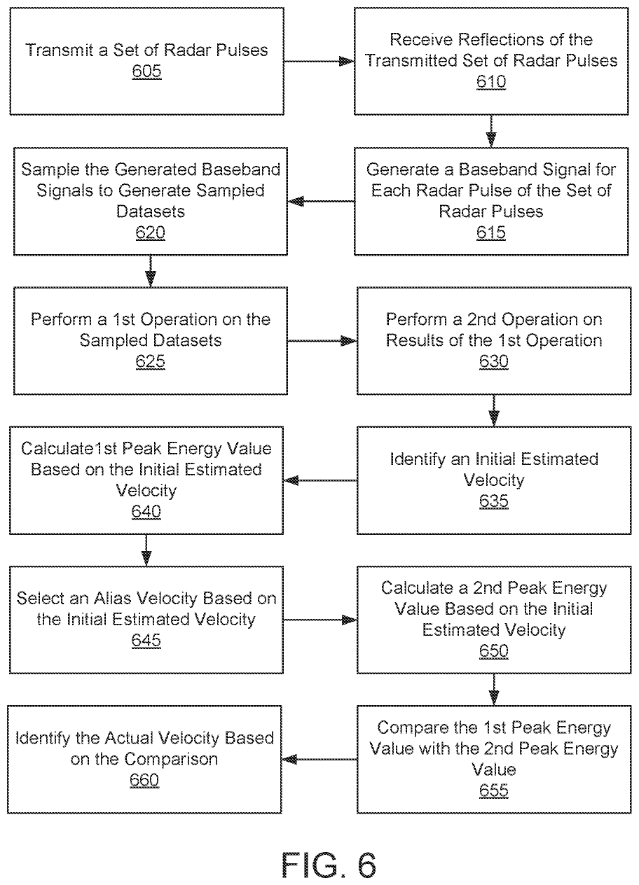

FIG. 6 illustrates actions that may be performed when a range to an object and a velocity of the object are identified during a single CPI of a radar device. At block 605 a set of radar pulses may be transmitted from a radar device. This may include transmitting multiple (e.g., 64, 126, or 256) radar pulses. At block 610, reflections of those transmitted radar pulses may be received. As mentioned above, the received radar pulses may be received after the transmitted radar pulses reflect off an object. At block 615 a baseband signal may be generated, for example, by mixing the transmitted radar pulses with the received radar pulses by a set of analog electronics.

At block 620, the generated baseband signals may be sampled. As discussed in respect to FIG. 3, data collected by sampling a baseband signal may be included in a set of sampled data. A baseband signal may be generated for each radar pulse transmitted at block 605 and each of these generated baseband signals may be sampled when respective sampled datasets are generated (e.g., one sampled dataset for each radar pulse). A first mathematical operation may be performed at block 625. This first mathematical operation may be a range-FFT as discussed in respect to FIGS. 2-5 above. This range-FFT may convert timing information into frequency information. Since the frequency of a baseband signal corresponds range to an object, the range to the object may be identified based on results of the range-FFT. At block 630 a second mathematical operation may be performed. This second mathematical operation may be a Doppler FFT discussed in respect to FIGS. 3 and 5 above. The Doppler FFT may be used to identify a Doppler frequency or phase shift from which an initial estimated velocity of an object may be identified at block 635.

At block 640 a first peak energy value may be calculated by generating sums of data associated with a set of range bins. This set of range bins may be identified based on a projection of the estimated velocity that corresponds to the object migrating from one range bin to another according to the estimated velocity. Since this first estimated velocity may not be an actual velocity of the object and instead be an aliased velocity, additional determinations may have to be performed to identify the actual velocity. In an instance when aliased velocities include 10 meters per second, 20 meters per second, and 30 meters per second, the initial estimated velocity may be 10 meters per second, yet this velocity may not be correct because of aliasing.

At block 645 an alias velocity may be selected based on the initial estimated velocity. This means that the aliased velocity selected at block 645 may be 20 meters per second. At block 650 a second peak energy value may be calculated. The first peak energy value and the second peak energy value may be compared at block 655. Peak energy values may be calculated for each respective relevant alias velocity. An actual velocity may be identified at block 660 based on the comparison performed at block 655. A velocity associated with the greatest value of peak energy calculated for each of a set of aliased velocities may be selected as the actual velocity.

A set of aliased velocities that include velocities of 10 meters per second, 20 meters per second, and 30 meters per second could potentially include other aliased velocities. For example, these other possible alias velocities could include 40, 50, and 60 meters per second. It may not be reasonable to calculate peak energy values for each of these aliased velocities, however. Velocities of 10, 20, and 30 meters per second (22.37, 44.74, and 67.10 miles per hour) may likely be encountered by a radar device in an automobile that is driving in a residential area where speed limits are set at 25 miles per hour as relative velocities between the automobile and another vehicle could likely exceed twice the speed limit. In this residential area, relative velocities between the automobile an object of 40, 50 or 60 meters per second (89.48, 111.85, and 134.22 miles per hour) may be considered unreasonable because such velocities are unlikely to be encountered in a residential area. Velocities of 40, 50 or 60 meters per second are more likely to be encountered in a highway setting and not in a residential area. Because of this, aliased velocities selected for an evaluation may be limited based on an environment where a radar device is located.

As mentioned above, data sensed, stored, or used by a radar device may include a value of sensed data, a time when that sensed data was received, a magnitude of energy associated with a sensed data sample, the presence or absence of an object detection (e.g., a binary yes=>1 or no=>0 indication), a number of detections, a range bin identifier, or combination thereof. Energy sensed by a radar device may only include noise (noise energy). This noise energy and the presence of less than some measure (e.g., a threshold level) of sensed energy may indicate that this sample is not or should not be associated with an object. Because of this, a magnitude of a sensed data point that is less than a threshold amplitude may be used to eliminate noise from being included in a set of sampled data. Furthermore, some operations may include summing binary 1 and/or 0 values instead of summing measures of received energy.

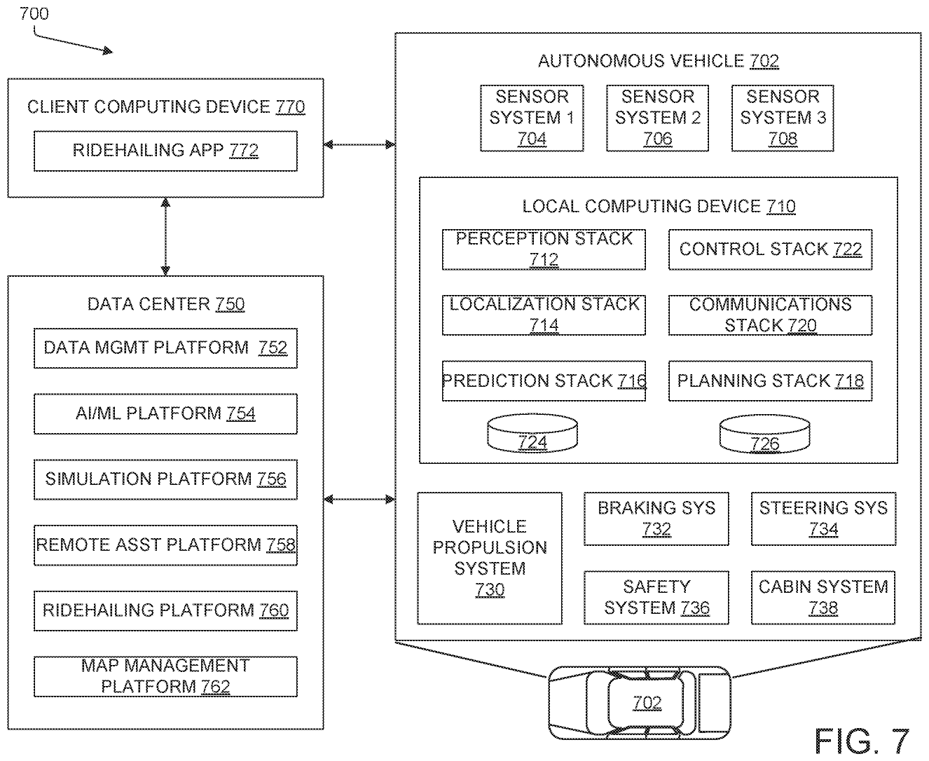

FIG. 7 is a diagram illustrating an example autonomous vehicle (AV) environment 700, according to some examples of the present disclosure. One of ordinary skill in the art will understand that, for AV environment 700 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 700 includes an AV 702, a data center 750, and a client computing device 770. The AV 702, the data center 750, and the client computing device 770 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 702 can navigate roadways without a human driver based on sensor signals generated by multiple sensor systems 704, 706, and 708. The sensor systems 704-708 can include one or more types of sensors and can be arranged about the AV 702. For instance, the sensor systems 704-708 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 704 can be a camera system, the sensor system 706 can be a LIDAR system, and the sensor system 708 can be a RADAR system. Other examples may include any other number and type of sensors.

The AV 702 can also include several mechanical systems that can be used to maneuver or operate the AV 702. For instance, the mechanical systems can include a vehicle propulsion system 730, a braking system 732, a steering system 734, a safety system 736, and a cabin system 738, among other systems. The vehicle propulsion system 730 can include an electric motor, an internal combustion engine, or both. The braking system 732 can include an engine brake, brake pads, actuators, and/or any other suitable componentry configured to assist in decelerating the AV 702. The steering system 734 can include suitable componentry configured to control the direction of movement of the AV 702 during navigation. The safety system 736 can include lights and signal indicators, a parking brake, airbags, and so forth. The cabin system 738 can include cabin temperature control systems, in-cabin entertainment systems, and so forth. In some examples, the AV 702 might not include human driver actuators (e.g., steering wheel, handbrake, foot brake pedal, foot accelerator pedal, turn signal lever, window wipers, etc.) for controlling the AV 702. Instead, the cabin system 738 can include one or more client interfaces (e.g., Graphical User Interfaces (GUIs), Voice User Interfaces (VUIs), etc.) for controlling certain aspects of the mechanical systems 730-738.

The AV 702 can include a local computing device 710 that is in communication with the sensor systems 704-708, the mechanical systems 730-738, the data center 750, and the client computing device 770, among other systems. The local computing device 710 can include one or more processors and memory, including instructions that can be executed by the one or more processors. The instructions can make up one or more software stacks or components responsible for controlling the AV 702; communicating with the data center 750, the client computing device 770, and other systems; receiving inputs from riders, passengers, and other entities within the AV's environment; logging metrics collected by the sensor systems 704-708; and so forth. In this example, the local computing device 710 includes a perception stack 712, a localization stack 714, a prediction stack 716, a planning stack 718, a communications stack 720, a control stack 722, an AV operational database 724, and an HD geospatial database 726, among other stacks and systems.

Perception stack 712 can enable the AV 702 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 704-708, the localization stack 714, the HD geospatial database 726, other components of the AV, and other data sources (e.g., the data center 750, the client computing device 770, third party data sources, etc.). The perception stack 712 can detect and classify objects and determine their current locations, speeds, directions, and the like. In addition, the perception stack 712 can determine the free space around the AV 702 (e.g., to maintain a safe distance from other objects, change lanes, park the AV, etc.). The perception stack 712 can identify environmental uncertainties, such as where to look for moving objects, flag areas that may be obscured or blocked from view, and so forth. In some examples, an output of the perception stack 712 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 714 can determine the AV's position and orientation (pose) using different methods from multiple systems (e.g., GPS, IMUs, cameras, LIDAR, RADAR, ultrasonic sensors, the HD geospatial database 726, etc.). For example, in some cases, the AV 702 can compare sensor data captured in real-time by the sensor systems 704-708 to data in the HD geospatial database 726 to determine its precise (e.g., accurate to the order of a few centimeters or less) position and orientation. The AV 702 can focus its search based on sensor data from one or more first sensor systems (e.g., GPS) by matching sensor data from one or more second sensor systems (e.g., LIDAR). If the mapping and localization information from one system is unavailable, the AV 702 can use mapping and localization information from a redundant system and/or from remote data sources.

Prediction stack 716 can receive information from the localization stack 714 and objects identified by the perception stack 712 and predict a future path for the objects. In some examples, the prediction stack 716 can output several likely paths that an object is predicted to take along with a probability associated with each path. For each predicted path, the prediction stack 716 can also output a range of points along the path corresponding to a predicted location of the object along the path at future time intervals along with an expected error value for each of the points that indicates a probabilistic deviation from that point.

Planning stack 718 can determine how to maneuver or operate the AV 702 safely and efficiently in its environment. For example, the planning stack 718 can receive the location, speed, and direction of the AV 702, geospatial data, data regarding objects sharing the road with the AV 702 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 702 from one point to another and outputs from the perception stack 712, localization stack 714, and prediction stack 716. The planning stack 718 can determine multiple sets of one or more mechanical operations that the AV 702 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 718 can select from multiple backup plans to carry out. For example, while preparing to change lanes to turn right at an intersection, another vehicle may aggressively cut into the destination lane, making the lane change unsafe. The planning stack 718 could have already determined an alternative plan for such an event. Upon its occurrence, it could help direct the AV 702 to go around the block instead of blocking a current lane while waiting for an opening to change lanes.

Control stack 722 can manage the operation of the vehicle propulsion system 730, the braking system 732, the steering system 734, the safety system 736, and the cabin system 738. The control stack 722 can receive sensor signals from the sensor systems 704-708 as well as communicate with other stacks or components of the local computing device 710 or a remote system (e.g., the data center 750) to effectuate operation of the AV 702. For example, the control stack 722 can implement the final path or actions from the multiple paths or actions provided by the planning stack 718. This can involve turning the routes and decisions from the planning stack 718 into commands for the actuators that control the AV's steering, throttle, brake, and drive unit.

Communications stack 720 can transmit and receive signals between the various stacks and other components of the AV 702 and between the AV 702, the data center 750, the client computing device 770, and other remote systems. The communications stack 720 can enable the local computing device 710 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 720 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 726 can store HD maps and related data of the streets upon which the AV 702 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 724 can store raw AV data generated by the sensor systems 704-708, stacks 712-722, and other components of the AV 702 and/or data received by the AV 702 from remote systems (e.g., the data center 750, the client computing device 770, etc.). In some examples, the raw AV data can include HD LIDAR point cloud data, image data, RADAR data, GPS data, and other sensor data that the data center 750 can use for creating or updating AV geospatial data or for creating simulations of situations encountered by AV 702 for future testing or training of various machine learning algorithms that are incorporated in the local computing device 710.

Data center 750 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 750 can include one or more computing devices remote to the local computing device 710 for managing a fleet of AVs and AV-related services. For example, in addition to managing the AV 702, the data center 750 may also support a ride-hailing service (e.g., a ridesharing service), a delivery service, a remote/roadside assistance service, street services (e.g., street mapping, street patrol, street cleaning, street metering, parking reservation, etc.), and the like.

Data center 750 can send and receive various signals to and from the AV 702 and the client computing device 770. These signals can include sensor data captured by the sensor systems 704-708, roadside assistance requests, software updates, ride-hailing/ridesharing pick-up and drop-off instructions, and so forth. In this example, the data center 750 includes a data management platform 752, an Artificial Intelligence/Machine Learning (AI/ML) platform 754, a simulation platform 756, a remote assistance platform 758, and a ride-hailing platform 760, and a map management platform 762, among other systems.

Data management platform 752 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 750 can access data stored by the data management platform 752 to provide their respective services.

The AI/ML platform 754 can provide the infrastructure for training and evaluating machine learning algorithms for operating the AV 702, the simulation platform 756, the remote assistance platform 758, the ride-hailing platform 760, the map management platform 762, and other platforms and systems. Using the AI/ML platform 754, data scientists can prepare data sets from the data management platform 752; select, design, and train machine learning models; evaluate, refine, and deploy the models; maintain, monitor, and retrain the models; and so on.

Simulation platform 756 can enable testing and validation of the algorithms, machine learning models, neural networks, and other development efforts for the AV 702, the remote assistance platform 758, the ride-hailing platform 760, the map management platform 762, and other platforms and systems. Simulation platform 756 can replicate a variety of driving environments and/or reproduce real-world scenarios from data captured by the AV 702, including rendering geospatial information and road infrastructure (e.g., streets, lanes, crosswalks, traffic lights, stop signs, etc.) obtained from a cartography platform (e.g., map management platform 762); modeling the behavior of other vehicles, bicycles, pedestrians, and other dynamic elements; simulating inclement weather conditions, different traffic scenarios; and so on.

Remote assistance platform 758 can generate and transmit instructions regarding the operation of the AV 702. For example, in response to an output of the AI/ML platform 754 or other system of the data center 750, the remote assistance platform 758 can prepare instructions for one or more stacks or other components of the AV 702.

Ride-hailing platform 760 can interact with a customer of a ride-hailing service via a ride-hailing application 772 executing on the client computing device 770. The client computing device 770 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 772. The client computing device 770 can be a customer's mobile computing device or a computing device integrated with the AV 702 (e.g., the local computing device 710). The ride-hailing platform 760 can receive requests to pick up or drop off from the ride-hailing application 772 and dispatch the AV 702 for the trip.

Map management platform 762 can provide a set of tools for the manipulation and management of geographic and spatial (geospatial) and related attribute data. The data management platform 752 can receive LIDAR point cloud data, image data (e.g., still image, video, etc.), RADAR data, GPS data, and other sensor data (e.g., raw data) from one or more AVs 702, Unmanned Aerial Vehicles (UAVs), satellites, third-party mapping services, and other sources of geospatially referenced data. The raw data can be processed, and map management platform 762 can render base representations (e.g., tiles (2D), bounding volumes (3D), etc.) of the AV geospatial data to enable users to view, query, label, edit, and otherwise interact with the data. Map management platform 762 can manage workflows and tasks for operating on the AV geospatial data. Map management platform 762 can control access to the AV geospatial data, including granting or limiting access to the AV geospatial data based on user-based, role-based, group-based, task-based, and other attribute-based access control mechanisms. Map management platform 762 can provide version control for the AV geospatial data, such as to track specific changes that (human or machine) map editors have made to the data and to revert changes when necessary. Map management platform 762 can administer release management of the AV geospatial data, including distributing suitable iterations of the data to different users, computing devices, AVs, and other consumers of HD maps. Map management platform 762 can provide analytics regarding the AV geospatial data and related data, such as to generate insights relating to the throughput and quality of mapping tasks.

In some embodiments, the map viewing services of map management platform 762 can be modularized and deployed as part of one or more of the platforms and systems of the data center 750. For example, the AI/ML platform 754 may incorporate the map viewing services for visualizing the effectiveness of various object detection or object classification models, the simulation platform 756 may incorporate the map viewing services for recreating and visualizing certain driving scenarios, the remote assistance platform 758 may incorporate the map viewing services for replaying traffic incidents to facilitate and coordinate aid, the ride-hailing platform 760 may incorporate the map viewing services into the client application 772 to enable passengers to view the AV 702 in transit en route to a pick-up or drop-off location, and so on.

While the autonomous vehicle 702, the local computing device 710, and the autonomous vehicle environment 700 are shown to include certain systems and components, one of ordinary skill will appreciate that the autonomous vehicle 702, the local computing device 710, and/or the autonomous vehicle environment 700 can include more or fewer systems and/or components than those shown in FIG. 7. For example, the autonomous vehicle 702 can include other services than those shown in FIG. 7 and the local computing device 710 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 7. An illustrative example of a computing device and hardware components that can be implemented with the local computing device 710 is described below with respect to FIG. 7.

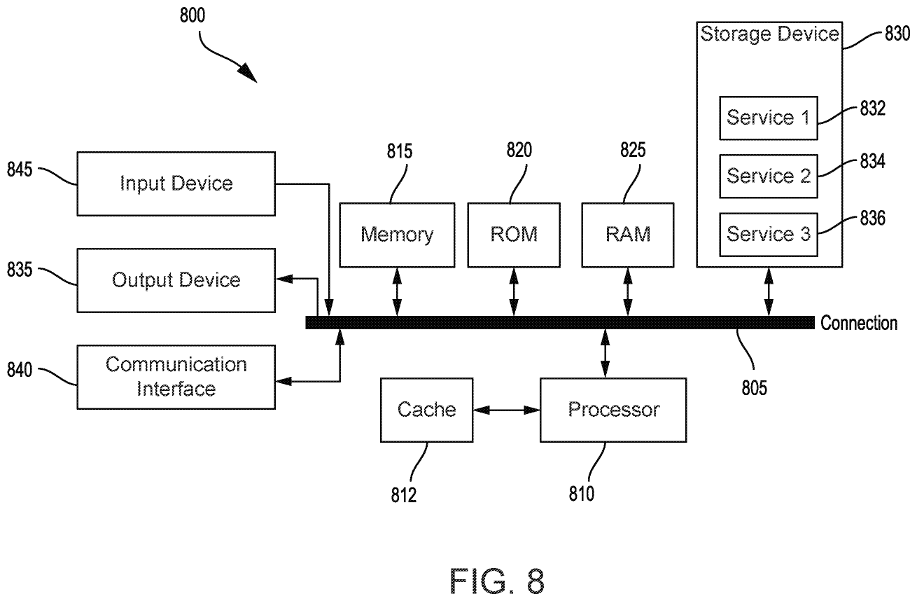

FIG. 8 illustrates an example processor-based system with which some aspects of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:

Aspect 1. A method comprising transmitting a set of radar pulses to determine an initial velocity estimate associated with an object; calculating a first peak energy return value corresponding with the initial velocity estimate; selecting an alias velocity based on the first velocity estimate; calculating a second peak energy return value corresponding with the alias velocity; and comparing the first peak energy return value with the second peak energy return value to determine an actual velocity of the object.

Aspect 2. The method of Aspect 1, wherein calculating the first peak energy return value further comprises: identifying a first set of selected range spans that correspond to the initial velocity estimate; and calculating the first peak energy return value based on an energy value associated with each respective range span of the first set of range spans that correspond to the initial velocity estimate.

Aspect 3. The method of Aspect 1 or Aspect 2, wherein comparing the first peak energy return value with the second peak energy return value further comprises determining that the alias velocity is the actual velocity of the object based on the second peak energy return value being greater than the first peak energy return value.

Aspect 4. The method of any of Aspects 1 through 3, wherein comparing the first peak energy return value with the second peak energy return value further comprises determining that the alias velocity is not the actual velocity of the object based on the second peak energy return value being greater than the first peak energy return value.

Aspect 5: The method of any of Aspects 1 through 4, further comprising receiving reflections of the transmitted set of radar pulses; generating a baseband signal for each of the set of radar pulses; and sampling the baseband signals generated for each of the set of radar pulses.

Aspect 6: The method Aspect 5, further comprising performing a first fast Fourier transform (FFT) on data associated with the sampled baseband signals; performing a second FFT on results of the first FFT; and identifying a Doppler shift based on results of the second FFT, wherein the initial velocity estimate is identified based on the identified Doppler shift.

Aspect 7: The method of any of Aspects 1 through 6, wherein the actual velocity of the object is determined in a single radar processing frame.

Aspect 8. A non-transitory computer-readable storage medium having embodied thereon instructions that when executed by one or more processors implement a method comprising: controlling transmission of a set of radar pulses to determine an initial velocity estimate associated with an object; calculating a first peak energy return value corresponding with the initial velocity estimate; selecting an alias velocity based on the first velocity estimate; calculating a second peak energy return value corresponding with the alias velocity; and comparing the first peak energy return value with the second peak energy return value to determine an actual velocity of the object.

Aspect 9. The non-transitory computer-readable storage medium of Aspect 8, wherein calculating the first peak energy return value further comprises: identifying a first set of selected range spans that correspond to the initial velocity estimate; and calculating the first peak energy return value based on an energy value associated with each respective range span of the first set of range spans that correspond to the initial velocity estimate.

Aspect 10. The non-transitory computer-readable storage medium of Aspect 8 or 9, wherein comparing the first peak energy return value with the second peak energy return value further comprises determining that the alias velocity is the actual velocity of the object based on the second peak energy return value being greater than the first peak energy return value.

Aspect 11. The non-transitory computer-readable storage medium of any of Aspects 8 through 10, wherein comparing the first peak energy return value with the second peak energy return value further comprises determining that the alias velocity is not the actual velocity of the object based on the second peak energy return value being greater than the first peak energy return value.

Aspect 12. The non-transitory computer-readable storage medium of any of Aspects 8 through 11, wherein: reflections of the transmitted set of radar pulses are received; a baseband signal for each of the set of radar pulses are generated; and each of the baseband signals are sampled by an analog to digital converter.

Aspect 13. The non-transitory computer-readable storage medium of Aspect 12, wherein the one or more processors execute the instructions to: perform a first fast Fourier transform (FFT) on data associated with the sampled baseband signals; perform a second FFT on results of the first FFT; and identify a Doppler shift based on results of the second FFT, wherein the initial velocity estimate is identified based on the identified Doppler shift.

Aspect 14. The non-transitory computer-readable storage medium of any of Aspects 8 through 13, wherein the actual velocity of the object is determined in a single radar processing frame.

Aspect 15. An apparatus comprising: a memory; and one or more processors that execute instructions out of the memory to: initiate transmission of a set of radar pulses to determine an initial velocity estimate associated with an object; calculate a first peak energy return value corresponding with the initial velocity estimate; select an alias velocity based on the first velocity estimate; calculate a second peak energy return value corresponding with the alias velocity; and compare the first peak energy return value with the second peak energy return value to determine an actual velocity of the object.

Aspect 16. The apparatus of Aspect 15, wherein calculating the first peak energy return value further comprises: identifying a first set of selected range spans that correspond to the initial velocity estimate; and calculating the first peak energy return value based on an energy value associated with each respective range span of the first set of range spans that correspond to the initial velocity estimate.

Aspect 17. The apparatus of Aspect 15 or 16, wherein comparing the first peak energy return value with the second peak energy return value further comprises determining that the alias velocity is the actual velocity of the object based on the second peak energy return value being greater than the first peak energy return value.

Aspect 18. The apparatus of any of Aspects 15 through 17, wherein comparing the first peak energy return value with the second peak energy return value further comprises determining that the alias velocity is not the actual velocity of the object based on the second peak energy return value being greater than the first peak energy return value.

Aspect 19. The apparatus of any of Aspects 15 through 18 wherein reflections of the transmitted set of radar pulses are received; a baseband signal for each of the set of radar pulses are generated; and each of the baseband signals are sampled by an analog to digital converter.

Aspect 20. The apparatus of any of Aspects 15 through 19, wherein the one or more processors execute the instructions to: perform a first fast Fourier transform (FFT) on data associated with the sampled baseband signals; perform a second FFT on results of the first FFT; and identify a Doppler shift based on results of the second FFT, wherein the initial velocity estimate is identified based on the identified Doppler shift.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
transmitting a set of radar pulses to determine an initial velocity estimate associated with an object;
calculating a first peak energy return value corresponding with the initial velocity estimate;
selecting an alias velocity based on the first velocity estimate;
calculating a second peak energy return value corresponding with the alias velocity; and
comparing the first peak energy return value with the second peak energy return value to determine an actual velocity of the object.

2. The method of claim 1, wherein calculating the first peak energy return value further comprises:
identifying a first set of selected range spans that correspond to the initial velocity estimate; and
calculating the first peak energy return value based on an energy value associated with each respective range span of the first set of range spans that correspond to the initial velocity estimate.

3. The method of claim 1, wherein comparing the first peak energy return value with the second peak energy return value further comprises determining that the alias velocity is the actual velocity of the object based on the second peak energy return value being greater than the first peak energy return value.

4. The method of claim 1, wherein comparing the first peak energy return value with the second peak energy return value further comprises determining that the alias velocity is not the actual velocity of the object based on the second peak energy return value being greater than the first peak energy return value.

5. The method of claim 1, further comprising:
receiving reflections of the transmitted set of radar pulses;
generating a baseband signal for each of the set of radar pulses; and
sampling the baseband signals generated for each of the set of radar pulses.

6. The method of claim 5, further comprising:
performing a first fast Fourier transform (FFT) on data associated with the sampled baseband signals;
performing a second FFT on results of the first FFT; and
identifying a Doppler shift based on results of the second FFT, wherein the initial velocity estimate is identified based on the identified Doppler shift.

7. The method of claim 1, wherein the actual velocity of the object is determined in a single radar processing frame.

8. A non-transitory computer-readable storage medium having embodied thereon instructions that when executed by one or more processors implement a method comprising:
controlling transmission of a set of radar pulses to determine an initial velocity estimate associated with an object;
calculating a first peak energy return value corresponding with the initial velocity estimate;
selecting an alias velocity based on the first velocity estimate;
calculating a second peak energy return value corresponding with the alias velocity; and
comparing the first peak energy return value with the second peak energy return value to determine an actual velocity of the object.

9. The non-transitory computer-readable storage medium of claim 8, wherein calculating the first peak energy return value further comprises:
identifying a first set of selected range spans that correspond to the initial velocity estimate; and
calculating the first peak energy return value based on an energy value associated with each respective range span of the first set of range spans that correspond to the initial velocity estimate.

10. The non-transitory computer-readable storage medium of claim 8, wherein comparing the first peak energy return value with the second peak energy return value further comprises determining that the alias velocity is the actual velocity of the object based on the second peak energy return value being greater than the first peak energy return value.

11. The non-transitory computer-readable storage medium of claim 8, wherein comparing the first peak energy return value with the second peak energy return value further comprises determining that the alias velocity is not the actual velocity of the object based on the second peak energy return value being greater than the first peak energy return value.

12. The non-transitory computer-readable storage medium of claim 8, wherein:
reflections of the transmitted set of radar pulses are received;
a baseband signal for each of the set of radar pulses are generated; and
each of the baseband signals are sampled by an analog to digital converter.

13. The non-transitory computer-readable storage medium of claim 12, wherein the one or more processors execute the instructions to:
perform a first fast Fourier transform (FFT) on data associated with the sampled baseband signals;
perform a second FFT on results of the first FFT; and
identify a Doppler shift based on results of the second FFT, wherein the initial velocity estimate is identified based on the identified Doppler shift.

14. The non-transitory computer-readable storage medium of claim 8, wherein the actual velocity of the object is determined in a single radar processing frame.

15. An apparatus comprising:
a memory; and
one or more processors that execute instructions out of the memory to:
initiate transmission of a set of radar pulses to determine an initial velocity estimate associated with an object;
calculate a first peak energy return value corresponding with the initial velocity estimate;
select an alias velocity based on the first velocity estimate;
calculate a second peak energy return value corresponding with the alias velocity; and
compare the first peak energy return value with the second peak energy return value to determine an actual velocity of the object.

16. The apparatus of claim 15, wherein calculating the first peak energy return value further comprises:
identifying a first set of selected range spans that correspond to the initial velocity estimate; and
calculating the first peak energy return value based on an energy value associated with each respective range span of the first set of range spans that correspond to the initial velocity estimate.

17. The apparatus of claim 15, wherein comparing the first peak energy return value with the second peak energy return value further comprises determining that the alias velocity is the actual velocity of the object based on the second peak energy return value being greater than the first peak energy return value.

18. The apparatus of claim 15, wherein comparing the first peak energy return value with the second peak energy return value further comprises determining that the alias velocity is not the actual velocity of the object based on the second peak energy return value being greater than the first peak energy return value.

19. The apparatus of claim 15, wherein:
reflections of the transmitted set of radar pulses are received;
a baseband signal for each of the set of radar pulses are generated; and
each of the baseband signals are sampled by an analog to digital converter.

20. The apparatus of claim 19, wherein the one or more processors execute the instructions to:
perform a first fast Fourier transform (FFT) on data associated with the sampled baseband signals;
perform a second FFT on results of the first FFT; and
identify a Doppler shift based on results of the second FFT, wherein the initial velocity estimate is identified based on the identified Doppler shift.
